(19) United States
(12) Patent Application Publication
(10) Pub. No.: US 2021/0326465 A1
(43) Pub. Date: Oct. 21, 2021

(54) METHOD, APPARATUS AND SYSTEM FOR DETERMINING AN APPLICATION PERMISSION

(71) Applicant: BEIJING DAJIA INTERNET INFORMATION TECHNOLOGY CO., LTD., Beijing (CN)

(72) Inventors: Bing Tan, Beijing (CN); Da Guo, Beijing (CN); Hongzhi Wang, Beijing (CN); Xin Li, Beijing (CN)

(21) Appl. No.: 17/224,436

(22) Filed: Apr. 7, 2021

(30) Foreign Application Priority Data
Apr. 16, 2020 (CN) 202010304104.7

(51) Int. Cl. G06F 21/62; G06F 21/44; G06F 21/31

(52) U.S. Cl. CPC G06F 21/629; G06F 21/31; G06F 21/44

(57) ABSTRACT

The disclosure relates to methods, apparatuses, and systems for determining an application permission including determining a current application scenario of a first application, in response to detect that a target user account triggers the first application to invoke a target application service of a second application and determining a target application permission corresponding to the target application service based on the current application scenario of the first application, such that the first application invokes the target application service based on the target application permission.

### CROSS-REFERENCE TO RELATED APPLICATIONS

This application is based upon and claims priority to Chinese Patent Application No. 202010304104.7, filed Apr. 16, 2020, the entirety of which is incorporated herein by reference.

### TECHNICAL FIELD

The disclosure relates to the field of Internet technology, and in particular to methods, apparatuses, and systems for determining an application permission.

### BACKGROUND

In related technologies, after a user logs in an application on a terminal, he can acquire authorization from a third-party application through the application, and acquire application services provided by the third-party application according to the authorization. For example, after logging in an application A, the user can acquire the authorization of an application B associated with the application A through the application A, such as login authorization, or the like. Then, the user can directly acquire application services provided by the application B through the application A according to the authorization, such as the login service.

However, in related technologies, when a user acquires permissions of the third-party application through an application, permissions for all user information of the third-party application are typically acquired, thereby increasing the leakage risk of user information.

### SUMMARY

The disclosure provides a method, apparatus, and system for determining an application permission.

According to some arrangements, a method for determining an application permission, applied to a terminal and includes determining a current application scenario of a first application, in response to detect that a target user account triggers the first application to invoke a target application service of a second application, and determining a target application permission corresponding to the target application service based on the current application scenario of the first application, such that the first application invokes the target application service based on the target application permission.

According to some arrangements, a method for determining an application permission, applied to a server and includes receiving a corresponding relationship acquisition request sent by a terminal in response to detecting that a target user account triggers a first application to invoke a target application service of a second application, and sending a corresponding relationship between each application scenario and an application permission of each application service corresponding to the target user account to the terminal based on the corresponding relationship acquisition request, such that the target user account determines a target application permission corresponding to the target application service based on the corresponding relationship and a current application scenario of the first application. The corresponding relationship between each application scenario and the application permission of each application service corresponding to the target user account is determined based on an invocation record of the application permission of each application service by the target user account under each application scenario.

According to some arrangements, a system for determining an application permission includes a terminal and a server. The terminal sends a corresponding relationship acquisition request to the server in response to detect that the target user account triggers a first application to invoke a target application service of a second application. The server receives the corresponding relationship acquisition request, and sends a corresponding relationship between each application scenario and an application permission of each application service corresponding to the target user account to the terminal based on the corresponding relationship acquisition request. The corresponding relationship between each application scenario and the application permission of each application service corresponding to the target user account is determined based on an invocation record of the application permission of each application service by the target user account under each application scenario. The terminal receives the corresponding relationship, and determines a target application permission corresponding to the target application service based on the corresponding relationship and a current application scenario of the first application, such that the first application invokes the application service to be invoked based on the target application permission.

According to some arrangements, an electronic device includes a processor and a memory for storing instructions executable by the processor. The processor is configured to execute the instructions to implement the methods for determining the application permission as described herein, or the methods for determining the application permission as described herein.

According to some arrangements, instructions in a storage medium, when executed by a processor of an electronic device, enable the electronic device to execute the methods for determining the application permission as described herein, or the methods for determining the application permission as described herein.

According to some arrangements, a computer program product when run on the device, causes the electronic device to execute the methods for determining the application permission as described herein, or the methods for determining the application permission as described herein.

It should be noted that the above general description and the following detailed description are merely examples and explanatory and should not be construed as limiting of the disclosure.

### BRIEF DESCRIPTION OF THE DRAWINGS

The drawings herein are incorporated into the specification and constitute a part of the specification, show arrangements conforming to the disclosure, and are used to explain the principle of the disclosure together with the specification, and do not constitute an improper limitation of the disclosure.

FIG. 1 is a flow chart showing a method for determining an application permission according to some example arrangements.

FIG. 2 is a flowchart showing another method for determining an application permission according to an some example arrangements

FIG. 3 is a schematic structural diagram showing a system for determining an application permission according to some example arrangements.

FIG. 4 is a block diagram showing an apparatus for determining an application permission according to some example arrangements.

FIG. 5 is a block diagram showing another apparatus for determining an application permission according to some example arrangements.

FIG. 6 is a block diagram showing a device for determining an application permission according to some example arrangements.

FIG. 7 is a block diagram showing another device for determining an application permission according to some example arrangements.

### DETAILED DESCRIPTION

In order to enable those of ordinary skill in the art to better understand the technical solutions of the disclosure, the technical solutions in the arrangements of the disclosure will be described clearly and completely with reference to the accompanying drawings.

It should be noted that the terms “first” and “second” in the specification, claims and the above-mentioned drawings of the disclosure are used to distinguish similar objects, and not necessarily used to describe a specific order or sequence. It should be understood that the data used in this way can be interchanged under appropriate circumstances, so that the arrangements of the disclosure described herein can be implemented in an order other than those illustrated or described herein. The implementations described in the following example arrangements do not represent all implementations consistent with the disclosure. Rather, they are merely examples of apparatuses and methods consistent with some aspects of the disclosure as detailed in the appended claims.

FIG. 1 is a flow chart showing a method for determining an application permission according to some example arrangements. As shown in FIG. 1, the method is applied to a terminal.

In block 11, a current application scenario of a first application is determined, in response to detect that a target user account triggers the first application to invoke a target application service of a second application.

In block 12, a target application permission corresponding to the target application service is determined based on the current application scenario of the first application, such that the first application invokes the target application service based on the target application permission.

In the arrangements shown in the disclosure, upon the target user logs in the first application on the terminal, the terminal can detect whether the target user account logging in the first application triggers the first application to invoke the target application service of the second application. The first application and the second application may be any application on the terminal, and may also be a specific application on the terminal, such as an application pre-designated by a relevant person. The first application and the second application may be different applications. In one example, the first application and the second application may be applications with a preset corresponding relationship; in another example, the first application and the second application may also be any two different applications on the terminal and have no corresponding relationships.

In such arrangements, the target user can be any login user of the first application, or a specific login user of the first application, such as a user of a specific level, a login user meeting a specific login condition (such as specific login time, a specific login location, etc.), or the like.

Similarly, the target application service can be any application service provided by the second application, or a specific application service provided by the second application; the target application service may have a preset corresponding relationship with the first application, or may have no preset corresponding relationships with the first application.

In response to the terminal detecting that the target user account triggers the first application to invoke the target application service of the second application, the current application scenario of the first application can be determined.

In some arrangements, the current application scenario of the first application may be determined according to the current page of the first application. The current page of the first application may be provided with controls or entries, such as buttons, hyperlinks, etc., that trigger the first application to invoke the target application service of the second application.

In some arrangements, in response to determining the current application scenario of the first application, the page parameter of the current page of the first application may be determined first. The page parameter may include at least one of a page label and a page URL (Uniform Resource Locator). After the page parameter of the current page of the first application is determined, the current application scenario of the first application may be determined according to the page parameter of the current page of the first application.

In an example, the terminal may determine a business label corresponding to the current page of the first application according to the page parameter of the current page of the first application. Then, the business label corresponding to the current page of the first application can be compared with the preset label. In response to determining that the matching is successful, the business type that has a preset corresponding relationship with the successfully matched preset label may be determined as the current application scenario of the first application.

In the above example, at least one business label can be preset in the page URL and the page label of the current page. Therefore, in response to determining the business label corresponding to the current page of the first application according to the page parameter of the current page of the first application, it may be determined directly according to the business label preset in the page URL and/or the page label of the current page of the first application.

For example, the page label of the current page of the first application may include the business label “login”. In response to determining the business label corresponding to the current page of the first application according to the page parameter of the current page of the first application, the business label corresponding to the current page of the first application may be determined as “login”. At this time, the business label of “login” can be compared with the preset label. If “login” exists in the preset label, the business type that has a preset corresponding relationship with the preset label “login”, such as “login business”, can be determined as the current application scenario of the first application.

It should be noted that In response to determining a plurality of business labels according to the page parameter of the current page of the first application, the preset business label corresponding to the control or entry touched in response to the target user account triggering the first application to invoke the target application service of the second application, and the preset business label is compared with the preset label. After the matching is successful, the business type corresponding to the successfully matched preset label is determined as the current application scenario of the first application.

Of course, in this arrangement, after a plurality of business labels are determined according to the page parameter of the current page of the first application, the plurality of business labels may be compared with the preset label. After the matching is successful, the business type corresponding to the successfully matched preset label is determined as the current application scenario of the first application. At this time, the current application scenario of the first application may be one or more.

After the current application scenario of the first application is determined, the target application permission corresponding to the target application service may be determined according to the current application scenario of the first application, so that the first application invokes the target application service based on the target application permission.

In the arrangement shown in the disclosure, in response to detecting that the target user account triggers the first application to invoke the target application service of the second application, the current application scenario of the first application may be determined, and the target application permission corresponding to the target application service may be determined according to the current application scenario of the first application, so that the first application invokes the target application service based on the target application permission.

It can be seen from the above content that the technical solutions provided by the arrangements of the disclosure can determine the current application scenario of the first application in response to determining that the first application invokes the target application service of the second application, and then determines it is the target application permission of the second application required to invoke the target application service for this time according to the current application scenario of the first application. In this way, as the application service of the second application is invoked through the first application, only the application permission of the second application required for invoking the application service can be acquired, and it is not necessary to acquire all the application permissions of the second application. It can reduce the leakage risk of user information and effectively solve technical problems in the related art.

In addition, in the arrangement shown in the disclosure, in response to determining the current application scenario of the first application, it may be determined according to the page parameter of the current page of the first application. The page parameter of the current page of the first application can well characterize the business type corresponding to the current page of the first application, and the business type can well characterize the application scenario, therefore, in response to determining the current application scenario of the first application according to the page parameter of the current page of the first application, the application scenario with high accuracy can be determined, and thus the accuracy of the target application permissions subsequently determined can be improved to a certain extent.

In another arrangement shown in the disclosure, in response to determining the target application permission corresponding to the target application service according to the current application scenario of the first application, the corresponding relationship between each application scenario of the first application and the application permission of each application service of the second application corresponding to the target user account may be acquired first, and then the target application permission corresponding to the target application service is determined according to the current application scenario of the first application and the corresponding relationship.

In one arrangement, as for different user accounts, the corresponding relationship between each application scenario of the first application and the application permission of each application service of the second application may be the same or different, which is not limited in this arrangement.

For example, the target user account may be user account 1, and the acquired corresponding relationship between each application scenario of the first application and the application permission of each application service of the second application corresponding to user account 1 may be as shown in Table 1.

TABLE 1

| | application permission of the |
|---|---|
| application scenario of the | application service of the second |
| first application | application |
| M | x |
| N | y |
| . . . | . . . |
| P | z |

The current application scenario of the first application may be scenario M, and then according to scenario M and the corresponding relationship shown in Table 1, it can be determined that the target application permission corresponding to the target application service is x.

It can be seen from the above content that in this arrangement, the target application permission corresponding to the target application service may be quickly and simply determined through the corresponding relationship between each application scenario of the first application and the application permission of each application service of the second application corresponding to the target user account, and the current application scenario of the first application, which is beneficial to quickly acquire the target application permission corresponding to the target application service, and invoke the target application service according to the target application permission. It can further improve the speed of permission invocation on the basis of reducing the leakage risk of user information, which further improves user satisfaction.

In the arrangement shown in the disclosure, in response to determining that the corresponding relationship between each application scenario of the first application and the application permission of each application service of the second application corresponding to the target user account is acquired, the corresponding relationship between each application scenario and the application permission of each application service corresponding to the target user account may be determined based on an invocation record of the application permission of each application service by the target user account under each application scenario. Then, the corresponding relationship between each application scenario of the first application and the application permission of each application service of the second application corresponding to the target user account may be determined from the corresponding relationship between each application scenario and the application permission of each application service corresponding to the target user account.

In an arrangement, the target user account may be user account 1, and the corresponding relationship between each application scenario and the application permission of each application service shown in Table 2 may be determined based on an invocation record of the application permission of each application service by the user account 1 under each application scenario, and then the corresponding relationship between each application scenario of the first application and the application permission of each application service of the second application corresponding to the user account 1 shown in Table 3 may be determined from the corresponding relationship shown in Table 2. The third application and the fourth application may be applications on the terminal different from the first application and the second application, and the third application and the fourth application may also be different applications.

TABLE 2

| | application permission of the |
|---|---|
| application scenario | application service |
| application scenario M of | application permission x of the |
| the first application | application service of the second |
| | application |
| application scenario M of | application permission x of the |
| the second application | application service of the third |
| | application |
| application scenario M of | application permission 1 of the |
| the first application | application service of the fourth |
| | application |
| application scenario N of | application permission y of the |
| the first application | application service of the second |
| | application |
| application scenario N of | application permission z of the |
| the second application | application service of the fourth |
| | application |
| . . . | . . . |
| application scenario P of | application permission z of the |
| the first application | application service of the second |
| | application |

TABLE 3

| | application permission of the |
|---|---|
| application scenario | application service |
| application scenario M of | application permission x of the |
| the first application | application service of the second |
| | application |
| application scenario N of | application permission y of the |
| the first application | application service of the second |
| | application |
| . . . | . . . |
| application scenario P of | application permission z of the |
| the first application | application service of the second |
| | application |

It can be seen from the above content that in this arrangement, the corresponding relationship between each application scenario and the application permission of each application service corresponding to the target user account can be determined based on the invocation record of the application permission of each application service by the target user account under each application scenario. Since the invocation record can truly reflect the historical invocation of the application permission of each application service by the target user account under each application scenario, the invocation record can well characterize the invocation tendency and invocation requirements of the application permission of each application service by the target user account under each application scenario. Therefore, in response to determining the corresponding relationship according to the invocation record, the determined corresponding relationship can well meet the needs of the target user account to a certain extent, so that the subsequently determined target application permission corresponding to the target application service is the permission that the target user account needs or wants to invoke, which can further improve user satisfaction on the basis of reducing the leakage risk of user information.

In the arrangement shown in the disclosure, the corresponding relationship between each application scenario of the first application and the application permission of each application service of the second application corresponding to the target user account may also be acquired through a server. In some arrangements, the corresponding relationship between each application scenario and the application permission of each application service corresponding to the target user account can be acquired from the server. The server may determine the corresponding relationship between each application scenario and the application permission of each application service corresponding to the target user account based on an invocation record of the application permission of each application service by the target user account under each application scenario. Then, the corresponding relationship between each application scenario of the first application and the application permission of each application service of the second application corresponding to the target user account may be determined from the corresponding relationship between each application scenario and the application permission of each application service corresponding to the target user account.

The detailed implementation process of this arrangement has been described in detail in the previous arrangement, so this arrangement does not limit this.

It can be seen from the above content that in this arrangement, the corresponding relationship between each application scenario of the first application and the application permission of each application service of the second application corresponding to the target user account may be acquired through a server. Since the determination process of the corresponding relationship can be implemented by the server and the terminal can directly acquire the corresponding relationship determined by the server from the server, the computing pressure of the terminal can be greatly reduced. In addition, since the computing ability and computing speed of the server can be stronger than that of the terminal, the terminal can quickly acquire the above corresponding relationship, which can effectively shorten the determination time of the target application permission corresponding to the target application service, reduce the waiting time of the target user account, and further improve user satisfaction on the basis of reducing the leakage risk of user information.

In the arrangement shown in the disclosure, in response to determining the corresponding relationship between each application scenario and the application permission of each application service corresponding to the target user account based on the invocation record of the application permission of each application service by the target user account under each application scenario, an initial permission mapping table corresponding to the target user account may be acquired. The initial permission mapping table may include an initial application permission for each application service by the target user account under each application scenario. Then, the initial permission mapping table may be updated based on the invocation record of the application permission of each application service by the target user account under each application scenario. After the update, the corresponding relationship between each application scenario and the application permission of each application service corresponding to the target user account may be determined based on the updated initial permission mapping table.

In this arrangement, the initial permission mapping table corresponding to the target user account may be acquired first. The initial permission mapping table can be manually set by the relevant personnel, or it can be set by default on the terminal. This arrangement does not limit this. For different user accounts, the initial permission mapping table can be the same or different. This arrangement does not limit this either.

After the initial permission mapping table corresponding to the target user account is acquired, the invocation record of the application permission of each application service by the target user account under each application scenario can be acquired, to determine the actual invocation of the application permission of each application service by the target user account under each application scenario. Then, the initial permission mapping table can be updated according to the actual invocation of the application permission of each application service by the target user account under each application scenario. The corresponding relationship between each application scenario and the application permission of each application service corresponding to the target user account may be determined based on the updated initial permission mapping table.

In this arrangement, since the initial permission mapping table can be updated according to the invocation record that characterizes the actual invocation, the updated initial permission mapping table can better meet the actual needs of the target user account. Therefore, in response to determining the corresponding relationship between each application scenario and the application permission of each application service corresponding to the target user account according to the updated initial permission mapping table, the determined corresponding relationship can better meet the actual needs of the target user account, so that the target application permission corresponding to the target application service subsequently determined by the determined corresponding relationship is the permission that the target user account needs or wants to invoke, which further improves user satisfaction on the basis of reducing the leakage risk of user information.

In the arrangement shown in the disclosure, the invocation record of the application permission of each application service by the target user account under each application scenario may include at least one of: the number of times of invoking each application service by the target user account under each application scenario, time consumed for invoking each application service by the target user account under each application scenario, and invocation feedback of each application service by the target user account under each application scenario, wherein the at least one of the number of times of invoking each application service, time consumed for invoking each application service, and invocation feedback of each application service is only the number of times of invoking each application service, only time consumed for invoking each application service, only invocation feedback of each application service, both the number of times of invoking each application service and time consumed for invoking each application service, both the at least one of the number of times of invoking each application service and invocation feedback of each application service, both time consumed for invoking each application service and invocation feedback of each application service, all of the number of times of invoking each application service, time consumed for invoking each application service and invocation feedback of each application service, or variations thereof. The invocation feedback includes rejecting the invocation, and manually adding a new application service and invoking the manually added new application service.

In this arrangement, in response to updating the initial permission mapping table based on the invocation record of the application permission of each application service by the target user account under each application scenario, if the number of times of invoking a certain application service by the target user account under a certain application scenario is low, for example, if it is lower than a first preset threshold of number of times, it can be determined that the target user account is not inclined to invoke the application service under the application scenario to a certain extent. At this time, the corresponding relationship between the application scenario and the application permission of the application service may be deleted from the initial permission mapping table. If time consumed for invoking a certain application service by the target user account under a certain application scenario is long, for example, if it is longer than a preset duration threshold, it can be determined that the target user account is not inclined to invoke the application service under the application scenario to a certain extent. At this time, the corresponding relationship between the application scenario and the application permission of the application service may be deleted from the initial permission mapping table. If the number and frequency of the target user account refusing to invoke a certain application service under a certain application scenario is relatively high, for example, higher than a second threshold of number of times (the second threshold of number of times can be the same as the first threshold of number of times, or different from the first threshold of number of times, for example, it can be smaller than the first threshold of number of times), frequency threshold, etc., it can also be determined that the target user account is not inclined to invoke the application service under the application scenario to a certain extent. At this time, the corresponding relationship between the application scenario and the application permission of the application service may be deleted from the initial permission mapping table. If the target user account manually adds a new application service under a certain application scenario and the number of times for invoking the manually added new application service is higher than the third threshold of number of times (the third threshold of number of times can be the same as the first threshold of number of times and the second threshold of number of times, or different from the first threshold of number of times, the second threshold of number of times, for example, it can be smaller than the first threshold of number of times, the second threshold of number of times), it can be determined that the target user account tends to invoke the newly added application service under the application scenario to a certain extent. At this time, the corresponding relationship between the application scenario and the newly added application service can be added to the initial permission mapping table.

In this arrangement, the invocation record of the application permission of each application service by the target user account under each application scenario may include invocation data in multiple dimensions, and may characterize the invocation tendency and invocation requirements in the multiple dimensions of the target user account to a certain extent. Therefore, the invocation record can well characterize the actual needs of the user. In response to determining the corresponding relationship between each application scenario and the application permission of each application service corresponding to the target user account based on the invocation record, the determined corresponding relationship well meets the actual needs of the target user account, so that the target application permission corresponding to the target application service subsequently determined by the determined corresponding relationship is the permission that the target user account needs or wants to invoke, which further improves user satisfaction on the basis of reducing the leakage risk of user information.

In arrangements of the disclosure, in response to updating the initial permission mapping table based on the invocation record of the application permission of each application service by the target user account under each application scenario, at least one of the following may be determined based on the invocation record of the application permission of each application service by the target user account under each application scenario, and the initial permission mapping table may be updated based on at least one of the following and a weight value preset for at least one of the following:

an acquisition success rate of the application permission of each application service by the target user account under each application scenario;

an acquisition failure rate of the application permission of each application service by the target user account under each application scenario;

a ranking value of time consumed in response to determining that the target user account successfully acquires the application permission of each application service under each application scenario in a first time consumed queue corresponding to the target user account, wherein the first time consumed queue corresponding to the target user account is formed by arranging the time consumed in response to determining that the target user account successfully acquires the application permission of each application service under each application scenario in a descending order;

a ranking value of time consumed in response to determining that the target user account fails to acquire the application permission of each application service under each application scenario in a second time consumed queue corresponding to the target user account, wherein the second time consumed queue corresponding to the target user account is formed by arranging the time consumed in response to determining that the target user account fails to acquire the application permission of each application service under each application scenario in an ascending order.

In an example, the invocation record of the application permission of each application service by the target user account under each application scenario may include the number of times of invocation. The number of times of invocation may include the number of times of successful invocation, the number of times of failed invocation, or the like. According to the number of times of invocation, the acquisition success rate and acquisition failure rate of the application permission of each application service by the target user account under each application scenario may be determined.

In an example, the invocation record of the application permission of each application service by the target user account under each application scenario may include time consumed for invoking each application service by the target user account under each application scenario. The consumed time may include time consumed in response to determining that the target user account successfully acquires the application permission of each application service under each application scenario, and may also include time consumed in response to determining that the target user account fails to acquire the application permission of each application service under each application scenario. According to the consumed time, a ranking value of time consumed in response to determining that the target user account successfully acquires the application permission of each application service under each application scenario in a first time consumed queue corresponding to the target user account may be acquired, and a ranking value of time consumed in response to determining that the target user account fails to acquire the application permission of each application service under each application scenario in a second time consumed queue corresponding to the target user account may also be acquired. The first time consumed queue corresponding to the target user account is formed by arranging the time consumed in response to determining that the target user account successfully acquires the application permission of each application service under each application scenario in a descending order. The second time consumed queue corresponding to the target user account is formed by arranging the time consumed in response to determining that the target user account fails to acquire the application permission of each application service under each application scenario in an ascending order.

In one arrangement, after at least one of the above is determined based on the invocation record of the application permission of each application service by the target user account under each application scenario, the initial permission mapping table may be updated based on at least one of the above and a weight value preset for at least one of the above.

During the update, a permission value can be determined based on at least one of the above and a weight value preset for at least one of the above. If the permission value is smaller than a preset permission threshold, the mapping relationship between the corresponding application scenario and the corresponding application permission of the application service may be deleted from the initial permission mapping table. In this arrangement, the preset permission thresholds corresponding to different application scenarios and application permissions of different application services may be the same or different, which is not limited in this arrangement.

For example, the target user account may be user account 1, and the initial permission mapping table corresponding to user account 1 may be as shown in Table 4:

TABLE 4

| | application permission of the |
|---|---|
| application scenario of the | application service of the second |
| first application | application |
| A | m |
| . . . | . . . |
| B | n |

The application scenario can include scenario A and scenario B. The application permission corresponding to scenario A in the initial permission mapping table corresponding to user account 1 can include permission m, and the application permission corresponding to scenario B in the initial permission mapping table corresponding to user account 1 can include permission n. Then, in response to updating the initial permission mapping table is updated according to the invocation record of the application permission of each application service by the target user account under each application scenario, an acquisition success rate 0.4 of permission m by user account 1 under scenario A and an acquisition success rate 0.6 of permission n by user account 1 under scenario B may be acquired respectively first; and an acquisition failure rate 0.6 of permission m by user account 1 under scenario A and an acquisition failure rate 0.4 of permission n by user account 1 under scenario B may be acquired respectively.

Then, time of 0.5 seconds consumed in response to determining that user account 1 successfully acquires permission m under scenario A and time of 0.3 seconds consumed in response to determining that user account 1 successfully acquires permission n under scenario B may be acquired respectively. After the above consumed time is determined, the above consumed time can be ranked in a descending order, and the first time consumed queue of (0.5; 0.3) corresponding to user account 1 is generated according to the ranking result. A first ranking number 1 of time consumed in response to determining that user account 1 successfully acquires permission m under scenario A in a first time consumed queue corresponding to user account 1, and a first ranking number 2 of time consumed in response to determining that user account 1 successfully acquires permission n under scenario B in a first time consumed queue corresponding to user account 1 can be determined.

0.7 seconds consumed in response to determining that user account 1 fails to acquire permission m under scenario A and 0.9 seconds consumed in response to determining that user account 1 fails to acquire permission n under scenario B may be acquired respectively. After the above consumed time is determined, the above consumed time can be ranked in an ascending order, and the second time consumed queue of (0.7; 0.9) corresponding to user account 1 is generated according to the ranking result. A second ranking number 1 of time consumed in response to determining that user account 1 fails to acquire permission m under scenario A in a second time consumed queue corresponding to user account 1, and a second ranking number 2 of time consumed in response to determining that user account 1 fails to acquire permission n under scenario B in a second time consumed queue corresponding to user account 1 can be determined.

Then, based on the acquisition success rate 0.4 of permission m by user account 1 under scenario A and a preset weight value 0.2 corresponding to the acquisition success rate, the acquisition failure rate 0.6 of permission m by user account 1 under scenario A and a preset weight value 0.2 corresponding to the acquisition failure rate, the first ranking number 1 of time consumed in response to determining that user account 1 successfully acquires permission m under scenario A in a first time consumed queue corresponding to user account 1 and a preset weight value 0.3 corresponding to the ranking number, and the second ranking number 1 of time consumed in response to determining that user account 1 fails to acquire permission m under scenario A in a second time consumed queue corresponding to user account 1 and a preset weight value 0.3 corresponding to the ranking number, it is determined that the corresponding permission value of permission m of user account 1 under scenario A is 0.4*0.2+0.6*0.2+1*0.3+1*0.3=0.8. As for user account 1, if the preset permission threshold corresponding to scenario A and permission m is 1, it can be determined that the permission value is smaller than the preset permission threshold. At this time, the mapping relationship between scenario A and permission m can be deleted from the initial permission mapping table.

Based on the acquisition success rate 0.6 of permission n by user account 1 under scenario B and a preset weight value 0.2 corresponding to the acquisition success rate, the acquisition failure rate 0.4 of permission n by user account 1 under scenario B and a preset weight value 0.2 corresponding to the acquisition failure rate, the first ranking number 2 of time consumed in response to determining that user account 1 successfully acquires permission n under scenario B in a first time consumed queue corresponding to user account 1 and a preset weight value 0.3 corresponding to the ranking number, and the second ranking number 2 of time consumed in response to determining that user account 1 fails to acquire permission n under scenario B in a second time consumed queue corresponding to user account 1 and a preset weight value 0.3 corresponding to the ranking number, it is determined that the corresponding permission value of permission n of user account 1 under scenario B is 0.6*0.2+0.4*0.2+2*0.3+2*0.3=1.4. As for user account 1, if the preset permission threshold corresponding to scenario B and permission n is 1, it can be determined that the permission value is larger than the preset permission threshold. At this time, the mapping relationship between scenario B and permission n can be retained in the initial permission mapping table.

It should be noted that in this example, each of determined first ranking number and second ranking number may also be multiplied with a preset coefficient (such as 0.1), and then perform the above calculation according to the multiplication result.

For example, the preset coefficient can be 0.1, and the corresponding permission value of permission n of user account 1 under scenario B determined above can be 0.6*0.2+0.4*0.2+2*0.1*0.3+2*0.1*0.3=0.32. At this time, as for user account 1, the preset permission threshold corresponding to scenario A and permission m may be 0.3.

In this arrangement, the initial permission mapping table can be updated according to the invocation data of multiple dimensions and the corresponding weight values. Since the invocation data of multiple dimensions can characterize the invocation tendency and invocation requirements in multiple dimensions of the target user account to a certain extent, the initial permission mapping table updated according to the invocation data of the multiple dimensions and the corresponding weight values can well characterize the actual needs of the user. The target application permission corresponding to the target application service determined according to the updated initial permission mapping table may be a permission that the target user account needs or wants to invoke, which further improves the user satisfaction on the basis of reducing the leakage risk of user information.

In an arrangement shown in the disclosure, the determining the target application permission corresponding to the target application service based on the current application scenario of the first application may be: determining a preset candidate application permission corresponding to the target application service based on the current application scenario of the first application; determining an any candidate application permission as the target application permission in response that a historical rejection rate of the any candidate application permission by the target user account under the current application scenario of the first application is smaller than a preset rejection rate threshold.

For example, the preset candidate application permission corresponding to the target application service determined according to the current application scenario of the first application includes permission m and permission n. A historical rejection rate of permission m by the target user account under the current application scenario of the first application is 0.3, and a historical rejection rate of permission n by the target user account under the current application scenario of the first application is 0.6. As for the target user account, if a preset rejection threshold of the candidate application permission under the current application scenario of the first application is 0.5, permission n can be determined as the target application permission, and at this time, permission m may not be determined as the target application permission.

In this arrangement, the target application permission can be determined according to the historical rejection rate of the candidate application permission by the target user account under the current application scenario of the first application. Since the permissions that the user does not want to acquire to a certain extent may be removed by combining with the actual rejection operation of the target user account, and only the permissions that the target user account is relatively inclined are retained, the determined target application permissions can well meet the actual needs of the target user account.

In an arrangement shown in the disclosure, said determining the target application permission corresponding to the target application service based on the current application scenario of the first application may be: determining application permissions manually added by the target user account under the current application scenario of the first application; determining the number of times of historical addition of application permissions manually added by the target user account under the current application scenario of the first application; determining the application permission whose number of times of addition is greater than a preset threshold of number of times as the target application permission corresponding to the target application service.

For example, the target user account has manually added permission m and permission n under the current application scenario of the first application. The number of times of historical manual addition to permission m is 5, and the number of times of historical manual addition to permission n is 10. If the preset threshold of number of times of the target user account under the current application scenario of the first application is 6, permission n can be determined as the target application permission, and at this time, permission m may not be determined as the target application permission.

In this arrangement, the target application permissions can be determined according to the manually added permissions by the target user account under the current application scenario of the first application. Since not only the target application permissions can be acquired according to the permission mapping table, but also the permissions that the target user account wants to acquire to a certain extent may be acquired by combining with the actual addition operation of the target user, the permissions that the target user account wants to acquire can be acquired more comprehensively, so as to well meet the actual needs of the target user account.

In an arrangement shown in the disclosure, said determining the target application permission corresponding to the target application service based on the current application scenario of the first application may be: determining a pending application permission corresponding to the target application service based on the current application scenario of the first application; inquiring whether the target user account invokes the pending application permission in response to determining that the pending application permission is an application permission that the target user account has not acquired under the current application scenario of the first application, and determining the pending application permission as the target application permission after the target user account allows the invocation.

In this arrangement, in response to determining the pending application permission corresponding to the target application service according to the current application scenario of the first application is an application permission that the target user account has not acquired under the current application scenario, since it cannot be determined whether the user is inclined to acquire the application permission, the target user account can be inquired whether to invoke the pending application permission, and the pending application permission is determined as the target application permission after the target user account allows the invocation.

In this arrangement, in response to determining that the determined pending application permission is an application permission that the target user account has not acquired under the current application scenario of the first application, the target user account may be used to determine whether to determine the pending application permission as the target application permission. Since the target user account itself can determine whether to determine the pending application permission as the target application permission in response to determining that the invocation tendency of the target user account cannot be determined, this arrangement can well meet the actual needs of the user.

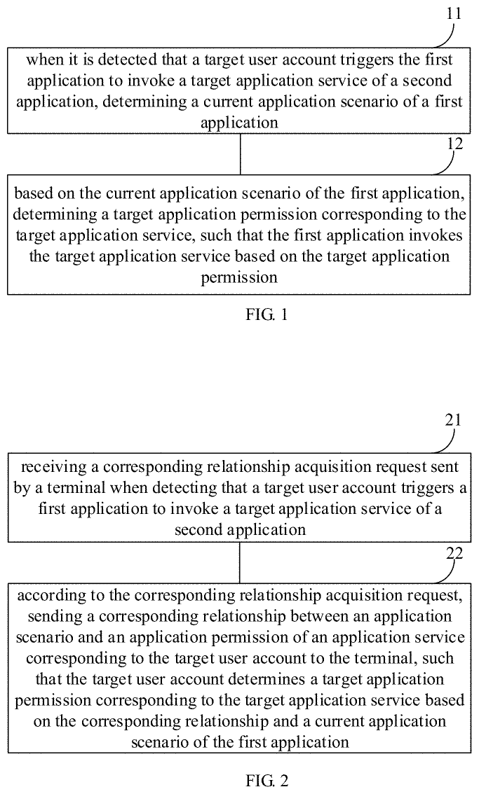

FIG. 2 is a flowchart showing another method for determining an application permission according to an example arrangement. As shown in FIG. 2, the method is applied to a server.

In block 21, a corresponding relationship acquisition request sent by a terminal in response to detecting that a target user account triggers a first application to invoke a target application service of a second application is received.

In block 22, a corresponding relationship between each application scenario and an application permission of each application service corresponding to the target user account is sent to the terminal based on the corresponding relationship acquisition request, such that the target user account determines a target application permission corresponding to the target application service based on the corresponding relationship and a current application scenario of the first application, wherein the corresponding relationship between each application scenario and the application permission of each application service corresponding to the target user account is determined based on an invocation record of the application permission of each application service by the target user account under each application scenario.

In this arrangement, in response to detecting that the target user account triggers the first application to invoke the target application service of the second application, the terminal may generate a corresponding relationship acquisition request, and send the generated corresponding relationship acquisition request to the server.

The first application and the second application may be any application on the terminal, and may also be a specific application on the terminal, such as an application pre-designated by a relevant person. The first application and the second application may be different applications. In one example, the first application and the second application may be applications with a preset corresponding relationship; in another example, the first application and the second application may also be any two different applications on the terminal and have no corresponding relationships.

In this arrangement, the target user can be any login user of the first application, or a specific login user of the first application, such as a user of a specific level, a login user meeting a specific login condition (such as specific login time, a specific login location, etc.), or the like. This arrangement does not limit this.

Similarly, the target application service can be any application service provided by the second application, or a specific application service provided by the second application; the target application service may have a preset corresponding relationship with the first application, or may have no preset corresponding relationships with the first application, which is also not limited in this arrangement.

After the corresponding relationship acquisition request is received, the server can acquire the corresponding relationship between each application scenario and the application permission of each application service corresponding to the target user account. The corresponding relationship is determined based on the invocation record of the application permission of each application service by the target user account under each application scenario.

In this arrangement, the corresponding relationship may be determined by the server according to the invocation record of the application permission of each application service by the target user account under each application scenario, or may be determined by other devices connected to the server and sent to the server, and this arrangement does not limit this.

After acquiring the corresponding relationship between each application scenario and the application permission of each application service corresponding to the target user account, the server may send the corresponding relationship to the terminal, so that the target user account determines the target application permission corresponding to the target application service based on the corresponding relationship and the current application scenario of the first application.

In this arrangement, after receiving the corresponding relationship acquisition request sent by the terminal in response to the terminal detecting that the target user account triggers the first application to invoke the target application service of the second application, the server may send the corresponding relationship between each application scenario and the application permission of each application service corresponding to the target user account to the terminal according to the corresponding relationship acquisition request, so that the target user account determines the target application permission corresponding to the target application service based on the corresponding relationship and the current application scenario of the first application. It can be seen that, in this arrangement, the server can return the corresponding relationship to the terminal according to the corresponding relationship request sent by the terminal, so that the terminal can determine the target application permission corresponding to the target application service. It achieves that in response to determining that the application service of the second application is invoked through the first application, only the target application permissions required to invoke the application service can be acquired, instead of acquiring all the application permissions of the second application, thus reducing the leakage risk of user information and effectively solving the technical problems in the related art.

In an arrangement shown in the disclosure, before sending the corresponding relationship between each application scenario and the application permission of each application service corresponding to the target user account to the target user account, the server may determine an initial permission mapping table corresponding to the target user account first, wherein the initial permission mapping table may include an initial application permission for each application service by the target user account under each application scenario; and then the server may update the initial permission mapping table based on the invocation record of the application permission of each application service by the target user account under each application scenario; and determine the corresponding relationship between each application scenario and the application permission of each application service corresponding to the target user account based on the updated initial permission mapping table.

In this arrangement, the server may preset the same initial permission mapping table for all user accounts, or may also preset different initial permission mapping tables for different user accounts, which is not limited in this arrangement.

After the initial permission mapping table corresponding to the target user account is determined, the invocation record of the application permission of each application service by the target user account under each application scenario can be acquired, to determine the actual invocation of the application permission of each application service by the target user account under each application scenario. Then, the initial permission mapping table can be updated according to the actual invocation of the application permission of each application service by the target user account under each application scenario. The corresponding relationship between each application scenario and the application permission of each application service corresponding to the target user account may be determined based on the updated initial permission mapping table.

In this arrangement, since the initial permission mapping table can be updated according to the invocation record that characterizes the actual invocation, the updated initial permission mapping table can better meet the actual needs of the target user account. Therefore, in response to determining the corresponding relationship between each application scenario and the application permission of each application service corresponding to the target user account according to the updated initial permission mapping table, the determined corresponding relationship can better meet the actual needs of the target user account, so that the target application permission corresponding to the target application service subsequently determined by the determined corresponding relationship is the permission that the target user account needs or wants to invoke, which further improves user satisfaction on the basis of reducing the leakage risk of user information.

In the arrangement shown in the disclosure, the invocation record of the application permission of each application service by the target user account under each application scenario includes at least one of: the number of times of invoking each application service by the target user account under each application scenario, time consumed for invoking each application service by the target user account under each application scenario, and invocation feedback of each application service by the target user account under each application scenario, wherein the invocation feedback includes rejecting the invocation, and manually adding a new application service and invoking the manually added new application service.

In this arrangement, in response to updating the initial permission mapping table based on the invocation record of the application permission of each application service by the target user account under each application scenario, if the number of times of invoking a certain application service by the target user account under a certain application scenario is low, for example, if it is lower than a fourth preset threshold of number of times, it can be determined that the target user account is not inclined to invoke the application service under the application scenario to a certain extent. At this time, the corresponding relationship between the application scenario and the application permission of the application service may be deleted from the initial permission mapping table. If time consumed for invoking a certain application service by the target user account under a certain application scenario is long, for example, if it is longer than a preset duration threshold, it can be determined that the target user account is not inclined to invoke the application service under the application scenario to a certain extent. At this time, the corresponding relationship between the application scenario and the application permission of the application service may be deleted from the initial permission mapping table. If the number and frequency of the target user account refusing to invoke a certain application service under a certain application scenario is relatively high, for example, higher than a fifth threshold of number of times (the fifth threshold of number of times can be the same as the fourth threshold of number of times, or different from the fourth threshold of number of times, for example, it can be smaller than the fourth threshold of number of times), frequency threshold, etc., it can also be determined that the target user account is not inclined to invoke the application service under the application scenario to a certain extent. At this time, the corresponding relationship between the application scenario and the application permission of the application service may be deleted from the initial permission mapping table. If the target user account manually adds a new application service under a certain application scenario and the number of times for invoking the manually added new application service is higher than the sixth threshold of number of times (the sixth threshold of number of times can be the same as the fourth threshold of number of times and the fifth threshold of number of times, or different from the fourth threshold of number of times, the fifth threshold of number of times, for example, it can be smaller than the fourth threshold of number of times, the fifth threshold of number of times), it can be determined that the target user account tends to invoke the newly added application service under the application scenario to a certain extent. At this time, the corresponding relationship between the application scenario and the newly added application service can be added to the initial permission mapping table.

In this arrangement, the invocation record of the application permission of each application service by the target user account under each application scenario may include invocation data in multiple dimensions, and may characterize the invocation tendency and invocation requirements in the multiple dimensions of the target user account to a certain extent. Therefore, the invocation record can well characterize the actual needs of the user. in response to determining the corresponding relationship between each application scenario and the application permission of each application service corresponding to the target user account based on the invocation record, the determined corresponding relationship well meets the actual needs of the target user account, so that the target application permission corresponding to the target application service subsequently determined by the determined corresponding relationship is the permission that the target user account needs or wants to invoke, which further improves user satisfaction on the basis of reducing the leakage risk of user information.

In arrangements of the disclosure, in response to updating the initial permission mapping table is updated based on the invocation record of the application permission of each application service by the target user account under each application scenario, at least one of the following may be determined based on the invocation record of the application permission of each application service by the target user account under each application scenario, and the initial permission mapping table may be updated based on at least one of the following and a weight value preset for at least one of the following:

an acquisition success rate of the application permission of each application service by the target user account under each application scenario;

an acquisition failure rate of the application permission of each application service by the target user account under each application scenario;

a ranking value of time consumed in response to determining that the target user account successfully acquires the application permission of each application service under each application scenario in a first time consumed queue corresponding to the target user account, wherein the first time consumed queue corresponding to the target user account is formed by arranging the time consumed in response to determining that the target user account successfully acquires the application permission of each application service under each application scenario in a descending order;

a ranking value of time consumed in response to determining that the target user account fails to acquire the application permission of each application service under each application scenario in a second time consumed queue corresponding to the target user account, wherein the second time consumed queue corresponding to the target user account is formed by arranging the time consumed in response to determining that the target user account fails to acquire the application permission of each application service under each application scenario in an ascending order.

In an example, the invocation record of the application permission of each application service by the target user account under each application scenario may include the number of times of invocation. The number of times of invocation may include the number of times of successful invocation, the number of times of failed invocation, or the like. According to the number of times of invocation, the acquisition success rate and acquisition failure rate of the application permission of each application service by the target user account under each application scenario may be determined.

In an example, the invocation record of the application permission of each application service by the target user account under each application scenario may include time consumed for invoking each application service by the target user account under each application scenario. The consumed time may include time consumed in response to determining that the target user account successfully acquires the application permission of each application service under each application scenario, and may also include time consumed in response to determining that the target user account fails to acquire the application permission of each application service under each application scenario. According to the consumed time, a ranking value of time consumed in response to determining that the target user account successfully acquires the application permission of each application service under each application scenario in a first time consumed queue corresponding to the target user account may be acquired, and a ranking value of time consumed in response to determining that the target user account fails to acquire the application permission of each application service under each application scenario in a second time consumed queue corresponding to the target user account may also be acquired. The first time consumed queue corresponding to the target user account is formed by arranging the time consumed in response to determining that the target user account successfully acquires the application permission of each application service under each application scenario in a descending order. The second time consumed queue corresponding to the target user account is formed by arranging the time consumed in response to determining that the target user account fails to acquire the application permission of each application service under each application scenario in an ascending order.

In one arrangement, after at least one of the above is determined based on the invocation record of the application permission of each application service by the target user account under each application scenario, the initial permission mapping table may be updated based on at least one of the above and a weight value preset for at least one of the above.

During the update, a permission value can be determined based on at least one of the above and a weight value preset for at least one of the above. If the permission value is smaller than a preset permission threshold, the mapping relationship between the corresponding application scenario and the corresponding application permission of the application service may be deleted from the initial permission mapping table. In this arrangement, the preset permission thresholds corresponding to different application scenarios and application permissions of different application services may be the same or different, which is not limited in this arrangement.

In this arrangement, the initial permission mapping table can be updated according to the invocation data of multiple dimensions and the corresponding weight values. Since the invocation data of multiple dimensions can characterize the invocation tendency and invocation requirements in multiple dimensions of the target user account to a certain extent, the initial permission mapping table updated according to the invocation data of the multiple dimensions and the corresponding weight values can well characterize the actual needs of the user. The target application permission corresponding to the target application service determined according to the updated initial permission mapping table may be a permission that the target user account needs or wants to invoke, which further improves the user satisfaction on the basis of reducing the leakage risk of user information.

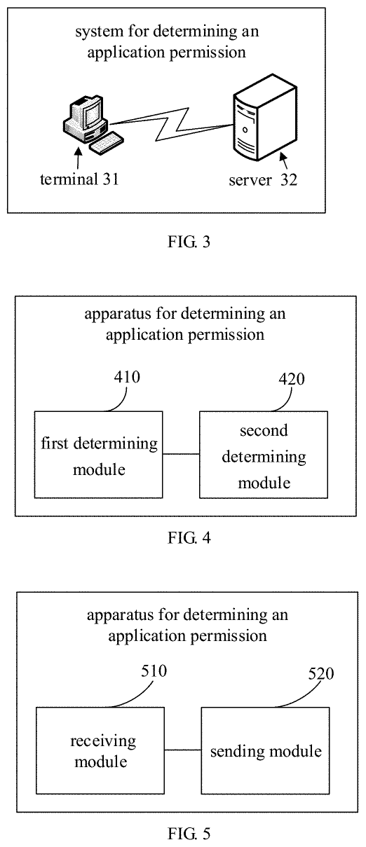

FIG. 3 is a schematic structural diagram of a system for determining an application permission according to an example arrangement. As shown in FIG. 3, the system includes a terminal 31 and a server 32.

The terminal 31 sends a corresponding relationship acquisition request to the server 32 in response to detect that the target user account triggers a first application to invoke a target application service of a second application.

The server 32 receives the corresponding relationship acquisition request, and sends a corresponding relationship between each application scenario and an application permission of each application service corresponding to the target user account to the terminal 31 based on the corresponding relationship acquisition request, wherein the corresponding relationship between each application scenario and the application permission of each application service corresponding to the target user account is determined based on an invocation record of the application permission of each application service by the target user account under each application scenario.

The terminal 31 receives the corresponding relationship, and determines a target application permission corresponding to the target application service based on the corresponding relationship and a current application scenario of the first application, such that the first application invokes the application service to be invoked based on the target application permission.

In the arrangement shown in the disclosure, a connection relationship between the terminal 31 and the server 32 can be established, and data interaction can be performed based on the connection relationship.

The terminal 31 may send a corresponding relationship acquisition request to the server 32 in response to detect that the target user account triggers a first application to invoke a target application service of a second application;

The foregoing arrangement has already explained the first application, the second application, the target user account, and the target application service, so this arrangement will not repeat them here.

After the server 32 receives the corresponding relationship acquisition request sent by the terminal 31, it may send a corresponding relationship between each application scenario and an application permission of each application service corresponding to the target user account to the terminal 31 based on the corresponding relationship acquisition request, wherein the corresponding relationship between each application scenario and the application permission of each application service corresponding to the target user account is determined based on an invocation record of the application permission of each application service by the target user account under each application scenario. The process of determining the corresponding relationship has been described in detail in the foregoing arrangement, which will not be repeated in the arrangement.

After the terminal 31 receives the corresponding relationship, it may determine a target application permission corresponding to the target application service based on the corresponding relationship and a current application scenario of the first application, such that the first application invokes the application service to be invoked based on the target application permission.

From the content disclosed in this arrangement, it can be seen that the terminal 31 may send a corresponding relationship acquisition request to the server 32 in response to detect that the target user account triggers a first application to invoke a target application service of a second application. The server 32 may receive the corresponding relationship acquisition request and send a corresponding relationship between each application scenario and an application permission of each application service corresponding to the target user account to the terminal 3 based on the corresponding relationship acquisition request. The terminal 31 may receive the corresponding relationship, and determines a target application permission corresponding to the target application service based on the corresponding relationship and a current application scenario of the first application, such that the first application invokes the application service to be invoked based on the target application permission. Given that in response to the application service of the second application being invoked through the first application, only the application permission of the second application required for invoking the application service can be acquired, and it is not necessary to acquire all the application permissions of the second application, it can reduce the leakage risk of user information and effectively solve technical problems in the related art.

FIG. 4 is a block diagram showing an apparatus for determining an application permission according to an example arrangement. Referring to FIG. 4, the apparatus includes a first determining module 410 and a second determining module 420.

The first determining module 410 is configured to determine a current application scenario of a first application, in response to detect that a target user account triggers the first application to invoke a target application service of a second application.

The second determining module 420 is configured to determine a target application permission corresponding to the target application service based on the current application scenario of the first application, such that the first application invokes the target application service based on the target application permission.

In some arrangements, the first determining module 410 is configured to:

determine a page parameter of a current page of the first application, wherein the current page is provided with a control or an entry that triggers the first application to invoke the target application service of the second application; the page parameter includes at least one of a page label and an uniform resource locator URL of a page;

determine the current application scenario of the first application based on the page parameter of the current page of the first application.

In some arrangements, the second determining module 420 is configured to:

acquire a corresponding relationship between each application scenario of the first application and an application permission of each application service of the second application corresponding to the target user account;

determine the target application permission corresponding to the target application service based on the current application scenario of the first application and the corresponding relationship.

In some arrangements, the second determining module 420 is further configured to:

determine the corresponding relationship between each application scenario and the application permission of each application service corresponding to the target user account, based on an invocation record of the application permission of each application service by the target user account under each application scenario;

determine the corresponding relationship between each application scenario of the first application and the application permission of each application service of the second application corresponding to the target user account, from the corresponding relationship between each application scenario and the application permission of each application service corresponding to the target user account;

or,

acquire the corresponding relationship between each application scenario and the application permission of each application service corresponding to the target user account from a server, wherein the server is configured to determine the corresponding relationship between each application scenario and the application permission of each application service corresponding to the target user account based on an invocation record of the application permission of each application service by the target user account under each application scenario;

determine the corresponding relationship between each application scenario of the first application and the application permission of each application service of the second application corresponding to the target user account, from the corresponding relationship between each application scenario and the application permission of each application service corresponding to the target user account.

In some arrangements, the second determining module 420 is further configured to:

acquire an initial permission mapping table corresponding to the target user account, wherein the initial permission mapping table includes an initial application permission for each application service by the target user account under each application scenario;

update the initial permission mapping table based on the invocation record of the application permission of each application service by the target user account under each application scenario;

determine the corresponding relationship between each application scenario and the application permission of each application service corresponding to the target user account, based on the updated initial permission mapping table.

In some arrangements, the invocation record of the application permission of each application service by the target user account under each application scenario includes at least one of: the number of times of invoking each application service by the target user account under each application scenario, time consumed for invoking each application service by the target user account under each application scenario, and invocation feedback of each application service by the target user account under each application scenario, wherein the invocation feedback includes rejecting the invocation, and manually adding a new application service and invoking the manually added new application service.

In some arrangements, the second determining module 420 is further configured to:

determine at least one of the following based on the invocation record of the application permission of each application service by the target user account under each application scenario, and update the initial permission mapping table based on at least one of the following and a weight value preset for at least one of the following:

an acquisition success rate of the application permission of each application service by the target user account under each application scenario;

an acquisition failure rate of the application permission of each application service by the target user account under each application scenario;

a ranking value of time consumed in response to determining that the target user account successfully acquires the application permission of each application service under each application scenario in a first time consumed queue corresponding to the target user account, wherein the first time consumed queue corresponding to the target user account is formed by arranging the time consumed in response to determining that the target user account successfully acquires the application permission of each application service under each application scenario in a descending order;

a ranking value of time consumed in response to determining that the target user account fails to acquire the application permission of each application service under each application scenario in a second time consumed queue corresponding to the target user account, wherein the second time consumed queue corresponding to the target user account is formed by arranging the time consumed in response to determining that the target user account fails to acquire the application permission of each application service under each application scenario in an ascending order.

In some arrangements, the second determining module 420 is configured to:

determine a preset candidate application permission corresponding to the target application service based on the current application scenario of the first application;

determine any candidate application permission as the target application permission in response that a historical rejection rate of the any candidate application permission by the target user account under the current application scenario of the first application is smaller than a preset rejection rate threshold.

In some arrangements, the second determining module 420 is configured to:

determine application permissions manually added by the target user account under the current application scenario of the first application;

determine the number of times of historical addition of application permissions manually added by the target user account under the current application scenario of the first application;

determine the application permission whose number of times of addition is greater than a preset threshold of number of times as the target application permission corresponding to the target application service.

In some arrangements, the second determining module 420 is configured to:

determine a pending application permission corresponding to the target application service based on the current application scenario of the first application;

inquire whether the target user account invokes the pending application permission in response to determining that the pending application permission is an application permission that the target user account has not acquired under the current application scenario of the first application, and determine the pending application permission as the target application permission after the target user account allows the invocation.

In the arrangement shown in the disclosure, in response to detecting that the target user account triggers the first application to invoke the target application service of the second application, the current application scenario of the first application may be determined, and the target application permission corresponding to the target application service may be determined according to the current application scenario of the first application, so that the first application invokes the target application service based on the target application permission.

It can be seen from the above content that the technical solutions provided by the arrangements of the disclosure can determine the current application scenario of the first application in response to determining that the first application invokes the target application service of the second application, and then determines it is the target application permission of the second application required to invoke the target application service for this time according to the current application scenario of the first application. In this way, in response to determining that the application service of the second application is invoked through the first application, only the application permission of the second application required for invoking the application service can be acquired, and it is not necessary to acquire all the application permissions of the second application. It can reduce the leakage risk of user information and effectively solve technical problems in the related art.

FIG. 5 is a block diagram showing another apparatus for determining an application permission according to an example arrangement. Referring to FIG. 5, the apparatus includes a receiving module 510 and a sending module 520.

The receiving module 510 is configured to receive a corresponding relationship acquisition request sent by a terminal in response to detecting that a target user account triggers a first application to invoke a target application service of a second application.

The sending module 520 is configured to send a corresponding relationship between each application scenario and an application permission of each application service corresponding to the target user account to the terminal based on the corresponding relationship acquisition request, such that the target user account determines a target application permission corresponding to the target application service based on the corresponding relationship and a current application scenario of the first application.

The corresponding relationship between each application scenario and the application permission of each application service corresponding to the target user account is determined based on an invocation record of the application permission of each application service by the target user account under each application scenario.

In some arrangements, the apparatus further includes following modules (not shown in FIG. 5):

a first determining module 530, configured to determine an initial permission mapping table corresponding to the target user account, wherein the initial permission mapping table includes an initial application permission for each application service by the target user account under each application scenario;

an updating module 540, configured to update the initial permission mapping table based on the invocation record of the application permission of each application service by the target user account under each application scenario;

a second determining module 550, configured to determine the corresponding relationship between each application scenario and the application permission of each application service corresponding to the target user account, based on the updated initial permission mapping table.

In some arrangements, the invocation record of the application permission of each application service by the target user account under each application scenario includes at least one of: the number of times of invoking each application service by the target user account under each application scenario, time consumed for invoking each application service by the target user account under each application scenario, and invocation feedback of each application service by the target user account under each application scenario, wherein the invocation feedback includes rejecting the invocation, and manually adding a new application service and invoking the manually added new application service.

In some arrangements, the updating module 540 is configured to:

determine at least one of the following based on the invocation record of the application permission of each application service by the target user account under each application scenario, and update the initial permission mapping table based on at least one of the following and a weight value preset for at least one of the following:

an acquisition success rate of the application permission of each application service by the target user account under each application scenario;

an acquisition failure rate of the application permission of each application service by the target user account under each application scenario;

a ranking value of time consumed in response to determining that the target user account successfully acquires the application permission of each application service under each application scenario in a first time consumed queue corresponding to the target user account, wherein the first time consumed queue corresponding to the target user account is formed by arranging the time consumed in response to determining that the target user account successfully acquires the application permission of each application service under each application scenario in a descending order;

a ranking value of time consumed in response to determining that the target user account fails to acquire the application permission of each application service under each application scenario in a second time consumed queue corresponding to the target user account, wherein the second time consumed queue corresponding to the target user account is formed by arranging the time consumed in response to determining that the target user account fails to acquire the application permission of each application service under each application scenario in an ascending order.

In this arrangement, after receiving the corresponding relationship acquisition request sent by the terminal in response to detecting that the target user account triggers the first application to invoke the target application service of the second application, the server may send the corresponding relationship between each application scenario and the application permission of each application service corresponding to the target user account to the terminal according to the corresponding relationship acquisition request, so that the target user account determines the target application permission corresponding to the target application service based on the corresponding relationship and the current application scenario of the first application. It can be seen that, in this arrangement, the server can return the corresponding relationship to the terminal according to the corresponding relationship request sent by the terminal, so that the terminal can determine the target application permission corresponding to the target application service. Accordingly, in response to determining that the application service of the second application is invoked through the first application, only the target application permissions required to invoke the application service can be acquired, instead of acquiring all the application permissions of the second application, thus reducing the leakage risk of user information and effectively solving the technical problems in the related art.

Regarding the apparatus in the foregoing arrangement, the specific manner in which each module performs the operation has been described in detail in the arrangement of the method, and a detailed description will not be given here.

The technical solutions provided by the arrangements of the disclosure at least bring the following beneficial effects:

a current application scenario of a first application can be determined, in response to detect that a target user account triggers the first application to invoke a target application service of a second application; and a target application permission corresponding to the target application service is determined based on the current application scenario of the first application, such that the first application invokes the target application service based on the target application permission.

It can be seen from the above content that the technical solution provided by the arrangements of the disclosure can determine the current application scenario of the first application in response to determining that the first application invokes the target application service of the second application, and then determines it is the target application permission of the second application required to invoke the target application service for this time, based on the current application scenario of the first application. In this way, in response to determining that the application service of the second application is invoked through the first application, the application permission of the second application required for invoking the application service can be adaptively determined and correspondingly acquired according to the current application scenario, so as to avoid the risk of user information leakage caused by acquiring all application permissions of the second application, and also reduce the failure rate of permission acquisition caused by acquiring too many application permissions, and improve the invocation efficiency of the application service.

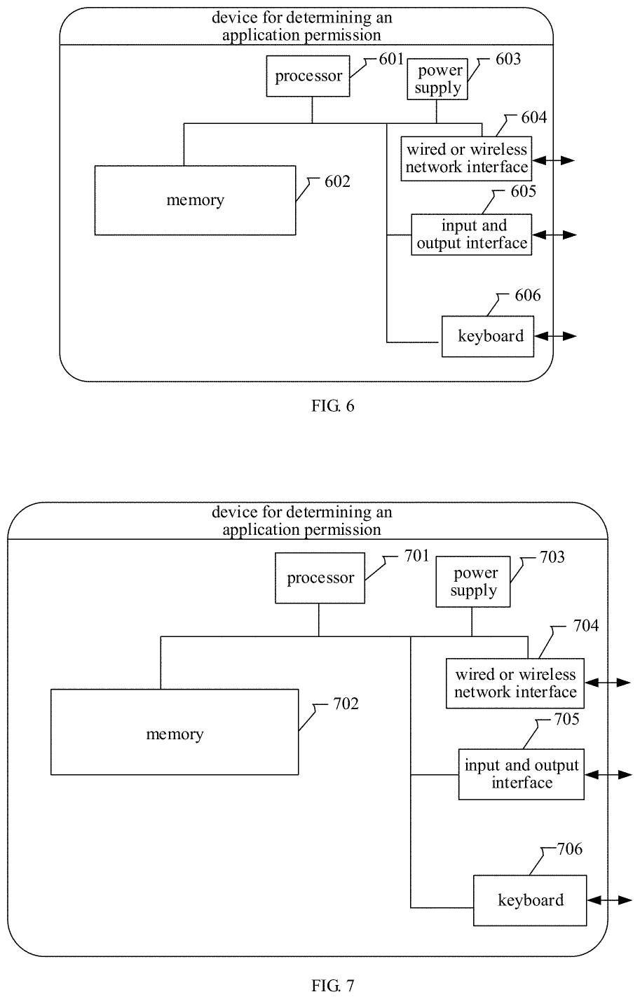

FIG. 6 is a block diagram showing a device for determining an application permission according to an example arrangement.

The device for determining the application permission may be the terminal device for determining the application permission provided in the foregoing arrangement.

The device for determining the application permission may have relatively large differences due to different configurations or performances, and may include one or more processors 601 and memories 602, and the memory 602 may store one or more stored application programs or data. The memory 602 may be short-term storage or persistent storage. The application program stored in the memory 602 may include one or more modules (not shown in the figure), and each module may include a series of computer-executable instructions in the device for determining the application permission. Further, the processor 601 may be configured to communicate with the memory 602, and a series of computer executable instructions in the memory 602 is executed on the device for determining the application permission. The device for determining the application permission may also include one or more power supplies 603, one or more wired or wireless network interfaces 604, one or more input and output interfaces 605, and one or more keyboards 606.

FIG. 7 is a schematic diagram showing the hardware structure of another device for determining an application permission according to an example arrangement.

The device for determining the application permission may be the server for determining the application permission provided in the foregoing arrangement.

The device for determining the application permission may have relatively large differences due to different configurations or performances, and may include one or more processors 701 and memories 702, and the memory 702 may store one or more stored application programs or data. The memory 702 may be short-term storage or persistent storage. The application program stored in the memory 702 may include one or more modules (not shown in the figure), and each module may include a series of computer-executable instructions in the device for determining the application permission. Further, the processor 701 may be configured to communicate with the memory 702, and a series of computer executable instructions in the memory 702 is executed on the device for determining the application permission. The device for determining the application permission may also include one or more power supplies 703, one or more wired or wireless network interfaces 704, one or more input and output interfaces 705, and one or more keyboards 706.

In the 1990s, the improvement of technology can be clearly distinguished between hardware improvements (for example, improvements in the circuit structure of diodes, transistors, switches, etc.) and software improvements (improvements in methods and procedures). However, with the development of technology, the improvement of many methods and procedures can be regarded as the direct improvement of the hardware circuit structure. Designers almost always get the corresponding hardware circuit structure by programming the improved method procedure into the hardware circuit. Therefore, it cannot say that the improvement of a method procedure cannot be realized by hardware entity modules. For example, a programmable logic device (PLD) (such as a Field Programmable Gate Array (FPGA)) is such an integrated circuit, whose logic function is determined by programming the device by the user. It is programmed by the designer to “integrate” a digital system on a PLD, without requiring the chip manufacturer to design and manufacture a dedicated integrated circuit chip. Moreover, nowadays, instead of manually manufacturing integrated circuit chips, this kind of programming is mostly realized by using “logic compiler” software, which is similar to the software compiler used in program development and writing. The original codes must also be written in a specific programming language, which is called Hardware Description Language (HDL), and there is not only one HDL, but many, such as ABEL (Advanced Boolean Expression Language), AHDL (Altera Hardware Description Language), Confluence, CUPL (Cornell University Programming Language), HDCal, JHDL (Java Hardware Description Language), Lava, Lola, MyHDL, PALASM, RHDL (Ruby Hardware Description Language), or the like. Currently, the most commonly used is VHDL (Very-High-Speed Integrated Circuit Hardware Description Language) and Verilog. It should also be clear to those skilled in the art that the hardware circuit that implements the logic method flow can be easily acquired by slight logic programming the method procedure using the above-mentioned hardware description languages and programming into an integrated circuit.

The controller can be implemented in any suitable manner. For example, the controller can take the form of a microprocessor or a processor and a computer-readable medium storing computer-readable program codes (such as software or firmware) executable by the (micro)processor, logic gates, switches, application specific integrated circuits (ASIC), programmable logic controllers, and embedded microcontrollers. Examples of controllers include but are not limited to the following microcontrollers: ARC 625D, Atmel AT91SAM, Microchip PIC18F26K20 and Silicone Labs C8051F320. The memory controller can also be implemented as a part of control logic of the memory. Those skilled in the art also know that, in addition to implementing the controller in a purely computer-readable program code manner, it is entirely possible to logic program the methods to make the controller realize the same function in the form of logic gates, switches, application specific integrated circuits, programmable logic controllers and embedded microcontroller, or the like. Therefore, such a controller can be regarded as a hardware component, and the apparatuses included in it for implementing various functions can also be regarded as a structure within the hardware component. Or even, the apparatus for realizing various functions can be regarded as both a software module for realizing the method and a structure within a hardware component.

The systems, apparatuses, modules or units explained in the above arrangements may be implemented by computer chips or entities, or implemented by products with certain functions. A typical implementation device is a computer. In some arrangements, the computer may be, for example, a personal computer, a laptop computer, a cell phone, a camera phone, a smart phone, a personal digital assistant, a media player, a navigation device, an email device, a game console, a tablet computer, a wearable device, or any combination of these devices.

For convenience of description, when the above apparatuses are described, they are divided into various units based on functions and described separately. Of course, when implementing the disclosure, the functions of each unit can be implemented in the same one or more software and/or hardware.

Those skilled in the art should understand that the arrangements of the disclosure may be provided as methods, systems, or computer program products. Therefore, the disclosure may adopt the form of a complete hardware arrangement, a complete software arrangement, or an arrangement combining software and hardware. Moreover, the disclosure may adopt the form of a computer program product implemented on one or more computer-usable storage media (including but not limited to disk storage, CD-ROM, optical storage, etc.) containing computer-usable program codes.

The disclosure is described with reference to flowcharts and/or block diagrams of methods, devices (systems), and computer program products according to arrangements of the disclosure. It should be understood that each process and/or block in the flowchart and/or block diagram, and the combination of processes and/or blocks in the flowchart and/or block diagram can be realized by computer program instructions. These computer program instructions can be provided to the processor of a general-purpose computer, a special-purpose computer, an embedded processor, or other programmable data processing devices to generate a machine, so that the instructions executed by the processor of the computer or other programmable data processing devices can generate a device that realizes the functions specified in one process or multiple processes in the flowchart and/or one block or multiple blocks in the block diagram.

These computer program instructions can also be stored in a computer-readable memory that works in a specific manner by a computer or other programmable data processing devices, so that the instructions stored in the computer-readable memory produce a manufacture article including the instruction apparatus. The instruction apparatus realizes the functions specified in one process or multiple processes in the flowchart and/or one block or multiple blocks in the block diagram.

These computer program instructions can also be loaded on a computer or other programmable data processing devices, so that a series of operation steps are executed on the computer or other programmable devices to produce computer-implemented processing, so that instructions execute on the computer or other programmable devices provide steps for implementing functions specified in a flow or multiple flows in the flowchart and/or a block or multiple blocks in the block diagram.

In a typical configuration, the computing device includes one or more processors (CPU), input/output interfaces, network interfaces, and memory.

The memory may include non-permanent memory in computer-readable media, random access memory (RAM) and/or non-volatile memory, such as read-only memory (ROM) or flash memory (flash RAM). The memory is an example of computer readable media.

The computer-readable media includes permanent and non-permanent, removable and non-removable media, and information storage can be realized by any method or technology. The information can be computer-readable instructions, data structures, program modules, or other data. Examples of computer storage media include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technologies, CD-ROM, digital versatile disc (DVD) or other optical storage, magnetic cassettes, magnetic tape magnetic disk storage or other magnetic storage devices or any other non-transmission media, which can be used to store information that can be accessed by computing devices. According to definition in this article, computer-readable media does not include transitory media, such as modulated data signals and carrier waves.

It should also be noted that the terms “include”, “contain” or any other variants thereof are intended to cover non-exclusive inclusion, so that a process, method, product or device including a series of elements not only includes those elements, but also includes other elements that are not explicitly listed, or further include elements inherent to the process, method, commodity, or device. If there are no more restrictions, the element defined by the sentence “including a . . . ” does not exclude the existence of other identical elements in the process, method, commodity or device that includes the elements.

Those skilled in the art should understand that the arrangements of the disclosure can be provided as a method, a system or a computer program product. Therefore, the disclosure may adopt the form of a complete hardware arrangement, a complete software arrangement, or an arrangement combining software and hardware. Moreover, the disclosure may adopt the form of a computer program product implemented on one or more computer-usable storage media (including but not limited to disk storage, CD-ROM, optical storage, etc.) containing computer-usable program codes.

The disclosure can be described in the general context of computer-executable instructions executed by a computer, such as a program module. Generally, program modules include routines, programs, objects, components, data structures, etc. that perform specific tasks or implement specific abstract data types. The disclosure can also be practiced in distributed computing environment, in which tasks are performed by remote processing devices connected through a communication network. In a distributed computing environment, program modules can be located in local and remote computer storage media including storage devices.

The various arrangements in this specification are described in a progressive manner, and the same or similar parts between the various arrangements can be referred to each other, and each arrangement focuses on the differences from other arrangements. In particular, as for the system arrangement, since it is basically similar to the method arrangement, the description is relatively simple. For related parts, please refer to the description of the method arrangement.

The foregoing descriptions are merely arrangements of the disclosure, and are not intended to limit the disclosure. For those skilled in the art, the disclosure can have various modifications and changes. Any modification, equivalent replacement, improvement, etc. made within the spirit and principle of the disclosure should be included in the scope of the claims of the disclosure.

It should be understood that the disclosure is not limited to the precise structure that has been described above and shown in the drawings, and various modifications and changes can be made without departing from its scope. The scope of the disclosure is limited only by the appended claims.

What is claimed is:

1. A method for determining an application permission, applied to a terminal and comprising:
determining a current application scenario of a first application, in response to detect that a target user account triggers the first application to invoke a target application service of a second application; and
determining a target application permission corresponding to the target application service based on the current application scenario of the first application, such that the first application invokes the target application service based on the target application permission.

2. The method of claim 1, where said determining the target application permission comprises:
acquiring a corresponding relationship between an application scenario of the first application corresponding to the target user account and an application permission of an application service of the second application respectively; and
determining the target application permission based on the current application scenario of the first application and the corresponding relationship.

3. The method of claim 2, where said acquiring the corresponding relationship comprises:
determining the corresponding relationship between each application scenario and the application permission of each application service corresponding to the target user account, based on an invocation record of the application permission of each application service by the target user account under each application scenario; and
determining the corresponding relationship between the application scenario of the first application corresponding to the target user account and the application permission of the application service of the second application respectively, from the corresponding relationship between each application scenario and the application permission of each application service corresponding to the target user account.

4. The method of claim 3, where said determining the corresponding relationship comprises:
acquiring a permission mapping table corresponding to the target user account, wherein the permission mapping table comprises application permissions of each application service under each application scenario for the target user account;
updating the permission mapping table based on the invocation record; and
determining the corresponding relationship based on the updated permission mapping table.

5. The method of claim 4, where said updating the initial permission mapping table based on the invocation record comprises:
updating the permission mapping table based on one or more of the following and a weight value preset for one or more of the following, wherein on one or more of the following are determined based on the invocation record:
an acquisition success rate of the application permission of each application service by the target user account under each application scenario;
an acquisition failure rate of the application permission of each application service by the target user account under each application scenario;
a ranking value of consuming time in a first consuming time queue, wherein the consuming time is a time at which the target user account successfully acquires the application permission of each application service under each application scenario, the first consuming time queue is a queue corresponding to the target user account, wherein the first consuming time queue is formed by arranging the consuming time at which the target user account successfully acquires the application permission of each application service under each application scenario in a descending order; or
a ranking value of consuming time in a second consuming time queue, wherein the consuming time is a time at which the target user account fails to acquire the application permission of each application service under each application scenario, the second consuming time queue is a queue corresponding to the target user account, wherein the second consuming time queue is formed by arranging the consuming time at which the target user account fails to acquire the application permission of each application service under each application scenario in an ascending order.

6. The method of claim 1, where said determining the current application scenario of the first application comprises:
determining a page parameter of a current page of the first application, wherein the current page is provided with a page element or an entry that triggers the first application to invoke the target application service of the second application; the page parameter comprises a page label or an uniform resource locator (URL) of a page or both of the page label and URL; and
determining the current application scenario of the first application based on the page parameter of the current page of the first application.

7. The method of claim 1, where said determining the target application permission comprises:
determining a candidate application permission corresponding to the target application service based on the current application scenario of the first application; and
determining a candidate application permission as the target application permission in response that a historical rejection rate of the candidate application permission by the target user account under the current application scenario of the first application is smaller than a rejection rate threshold.

8. The method of claim 1, where said determining the target application permission comprises:
obtaining adding times of application permissions added by the target user account under the current application scenario of the first application respectively; and
determining the application permission as the target application permission corresponding to the target application service under a condition that the adding times of the application permission is greater than a threshold of times.

9. The method of claim 1, where said determining the target application permission comprises:
determining a pending application permission corresponding to the target application service based on the current application scenario of the first application; and
inquiring the target user account to invoke or not invoke the pending application permission in response to determining that the pending application permission is an application permission that the target user account has not acquired under the current application scenario of the first application, and determining the pending application permission as the target application permission after the target user account allows the invocation.

10. An apparatus for determining an application permission, applied to a terminal and comprising:
a processor; and
a memory for storing instructions executable by the processor,
wherein the processor is configured to:
determine a current application scenario of a first application, in response to detect that a target user account triggers the first application to invoke a target application service of a second application; and
determine a target application permission corresponding to the target application service based on the current application scenario of the first application, such that the first application invokes the target application service based on the target application permission.

11. The apparatus for determining an application permission according to claim 10, wherein the processor is further configured to:
acquire a corresponding relationship between an application scenario of the first application corresponding to the target user account and an application permission of an application service of the second application respectively; and
determine the target application permission based on the current application scenario of the first application and the corresponding relationship.

12. The apparatus for determining an application permission according to claim 10, wherein the processor is further configured to:
determine a page parameter of a current page of the first application, wherein the current page is provided with a page element or an entry that triggers the first application to invoke the target application service of the second application; the page parameter comprises a page label or an uniform resource locator (URL) of a page or both of the page label and URL; and
determine the current application scenario of the first application based on the page parameter of the current page of the first application.

13. The apparatus for determining an application permission according to claim 10, wherein the processor is further configured to:
determine a candidate application permission corresponding to the target application service based on the current application scenario of the first application; and
determine a candidate application permission as the target application permission in response that a historical rejection rate of the candidate application permission by the target user account under the current application scenario of the first application is smaller than a rejection rate threshold.

14. The apparatus for determining an application permission according to claim 10, wherein the processor is further configured to:
obtain the adding times of application permissions added by the target user account under the current application scenario of the first application respectively; and
determine the application permission as the target application permission corresponding to the target application service under a condition that the adding times of the application permission is greater than a threshold of times.

15. The apparatus for determining an application permission according to claim 10, wherein the processor is further configured to:
determine a pending application permission corresponding to the target application service based on the current application scenario of the first application; and
inquire the target user account to invoke or not invoke the pending application permission in response to determining that the pending application permission is an application permission that the target user account has not acquired under the current application scenario of the first application, and determine the pending application permission as the target application permission after the target user account allows the invocation.

16. A system for determining an application permission, comprising s a terminal and a server,
wherein the terminal sends a corresponding relationship acquisition request to the server in response to detect that the target user account triggers a first application to invoke a target application service of a second application;
the server receives the corresponding relationship acquisition request, and sends a corresponding relationship between each application scenario and an application permission of each application service corresponding to the target user account to the terminal based on the corresponding relationship acquisition request, wherein the corresponding relationship between each application scenario and the application permission of each application service corresponding to the target user account is determined based on an invocation record of the application permission of each application service by the target user account under each application scenario; and
the terminal receives the corresponding relationship, and determines a target application permission corresponding to the target application service based on the corresponding relationship and a current application scenario of the first application, such that the first application invokes the application service to be invoked based on the target application permission.

17. The system of claim 16, wherein the server is further configured to:
determine a permission mapping table corresponding to the target user account, wherein the permission mapping table comprises application permissions of each application service under each application scenario for the target user account;
update the permission mapping table based on the invocation record; and
determine the corresponding relationship based on the updated permission mapping table.

18. The system of claim 17, wherein the invocation record of the application permission of each application service by the target user account under each application scenario comprises at least one of: the number of times of invoking each application service by the target user account under each application scenario, time consumed for invoking each application service by the target user account under each application scenario, and invocation feedback of each application service by the target user account under each application scenario, wherein the invocation feedback comprises rejecting the invocation, and manually adding a new application service and invoking the manually added new application service.

19. The system of claim 18, wherein the server is further configured to:
update the permission mapping table based on one or more of the following and a weight value preset for one or more of the following, wherein on one or more of the following are determined based on the invocation record:
an acquisition success rate of the application permission of each application service by the target user account under each application scenario;
an acquisition failure rate of the application permission of each application service by the target user account under each application scenario;
a ranking value of consuming time in a first consuming time queue, wherein the consuming time is a time at which the target user account successfully acquires the application permission of each application service under each application scenario, the first consuming time queue is a queue corresponding to the target user account, wherein the first consuming time queue is formed by arranging the consuming time at which the target user account successfully acquires the application permission of each application service under each application scenario in a descending order; or
a ranking value of consuming time in a second consuming time queue, wherein the consuming time is a time at which the target user account fails to acquire the application permission of each application service under each application scenario, the second consuming time queue is a queue corresponding to the target user account, wherein the second consuming time queue is formed by arranging the consuming time at which the target user account fails to acquire the application permission of each application service under each application scenario in an ascending order.
